(19) United States
(12) Patent Application Publication
(10) Pub. No.: US 2017/0262934 A1
(43) Pub. Date: Sep. 14, 2017

(54) METHOD AND APPARATUS FOR TRACKING PAYMENTS

(71) Applicant: MasterCard International Incorporated, Purchase, NY (US)

(72) Inventors: Moreshwar Mukund Datye, Maharashtra (IN); Vishwam Shekhar Singh, Maharashtra (IN); Ashutosh Subhash Gijare, Maharashstra (IN); Manglesh Suresh Deria, Maharashtra (IN); Monika Bhayana, Haryana (IN); Pradeep Unde, Maharashtra (IN)

(21) Appl. No.: 15/446,355

(22) Filed: Mar. 1, 2017

(30) Foreign Application Priority Data
Mar. 9, 2016 (SG) 10201601835Y

(51) Int. Cl. G06Q 40/02

(52) U.S. Cl. CPC G06Q 40/025

(57) ABSTRACT

A computer-implemented method for tracking payments is provided. The method comprises (a) receiving an electronic request for tracking payments; (b) obtaining, by a transaction analysis component, transaction records representing a plurality of transactions associated with a vendor from at least one database, each said transaction record comprises a plurality of information fields including a transaction amount, said plurality of transactions being performed via a payment network, operation (b) further comprising (i) identifying one or more credit transaction records representing one or more first transactions made using one of pre-defined payment devices with a terminal of the vendor, said one or more first transactions being for one or more orders made with the vendor, and (ii) identifying one or more debit transaction records representing one or more second transactions, wherein the one or more second transactions are purchases made by the vendor with one of designated third parties; and (c) calculating, by the transaction analysis component, a transaction-flow index representing a likelihood of the purchases being for fulfilling the one or more orders, based on a balance of the one or more credit and debit transaction records. An apparatus for performing the method is also disclosed.

### CROSS-REFERENCE TO RELATED APPLICATION

This application is a U.S. National Stage filing under 35 U.S.C. §119, based on and claiming benefits of and priority to SG Patent Application No. 10201601835Y filed Mar. 9, 2016.

### TECHNICAL FIELD AND BACKGROUND

This invention relates to a method and apparatus for tracking payment transactions. In particular, it provides a method and apparatus for tracking transactions made by a payment device holder.

Access to loans (i.e. working capitals) could be difficult if a potential borrower does not have an existing credit history or record, as commercial lenders may not be confident that the debt can be recovered given a lack of guarantee and missing collaterals.

Quantifying expenditures and losses may be difficult due to a lack of formal financing in domains such as agriculture, philanthropy etc. Existing systems provide methods of availing credit which tend to be far too bureaucratic and time consuming. This leads to further informal financing avenues with associated malpractices and exploitation. Therefore, it would be desirable to provide a method for tracking spending to determine if it is in alignment with a purpose of the credit.

### SUMMARY

The present invention aims to provide a simple and reliable way of tracking spending to determine if they are made in alignment with a purpose of a credit. This may be achieved by tracking a plurality of transactions performed over a payment network.

According to a first aspect, there is provided a computer-implemented method for tracking payments. The method comprises:

(a) receiving an electronic request for tracking payments;

(b) obtaining, by a transaction analysis component, transaction records representing a plurality of transactions associated with a vendor from at least one database, each said transaction record comprises a plurality of information fields including a transaction amount, said plurality of transactions being performed via a payment network, operation (b) further comprising:
(i) identifying one or more credit transaction records representing one or more first transactions made using one of pre-defined payment devices with a terminal of the vendor, said one or more first transactions being for one or more orders made with the vendor, and
(ii) identifying one or more debit transaction records representing one or more second transactions, wherein the one or more second transactions are purchases made by the vendor with one of designated third parties; and

(c) calculating, by the transaction analysis component, a transaction-flow index representing a likelihood of the purchases being for fulfilling the one or more orders, based on a balance of the one or more credit and debit transaction records.

For example, a creditor provides a borrower with a dedicated payment device to perform transactions, such as purchases. The transactions performed using the dedicated payment device with a vendor are identified. At the same time, transactions carried out by the vendor with a designated third party may be identified. Based on transaction records of the above transactions, a balance may be calculated. It may be deduced based on the balance whether the transactions carried out by the dedicated payment device is in line with the purpose of the credit. In other words, it may allow payments and purchases carried out by respective parties of a value chain (i.e. a sequence of purchasing transactions carried out to deliver a product) to be tracked and queried.

In one embodiment, the payment devices may be associated with respective payment device holders.

In one embodiment, the payment device may be a credit card authorized to perform a transaction only with a pre-defined list of vendors.

In one embodiment, the plurality of information fields may comprise a transaction time.

In one embodiment, the plurality of information fields may comprise an identity of the payment device.

In one embodiment, operation (c) may comprise calculating the balance of the one or more credit and debit transaction records at pre-defined time intervals.

In one embodiment, the method may further comprise, for one of the first transactions, identifying one or more of the second transactions as plausible transactions for fulfilling the order of the corresponding first transaction.

In one embodiment, the credit transaction record may comprise information about a product category of said order.

In one embodiment, the debit transaction record may comprise a merchant category code of said designated third party.

In one embodiment, the method may further comprise transmitting the transaction records of the plausible transactions and the corresponding first transaction.

In one embodiment, the method may further comprise selecting a sub-set of the information fields of each said transaction record for transmission.

According to a second aspect, there is provided an apparatus for tracking payments. The apparatus has a processor and a data storage device, the data storage device storing instructions operative by the processor to cause the processor to perform a method as disclosed above.

According to a further aspect, there is provided a non-transitory computer-readable medium for tracking payments. The computer-readable medium has stored thereon program instructions for causing at least one processor to perform a method as disclosed above.

The term “vendor” refers to an entity (including any individual or organization) in the supply chain that makes goods and services available to companies or consumers. In the present context, the vendor refers to an entity who, for an order made by a consumer, procures the goods or services from another party such as a wholesaler for fulfilling the order. Note that a consumer may be an individual or an organization who makes a payment for the product provided but may not be the end-consumer which receives the product. For example, a philanthropic organization is a consumer who makes purchases from food suppliers and redistributes the food to the needy.

Note that the term “product” is used in this document to include any goods such as physical objects and data products (e.g. software) or services.

### BRIEF DESCRIPTION OF THE DRAWINGS

Embodiments of the invention will now be described for the sake of non-limiting example only, with reference to the following drawings in which:

FIG. 1 is a flow diagram of a method according to an embodiment of the invention;

FIG. 2 is a block diagram illustrating an apparatus according to an embodiment;

FIG. 3 shows an example of a ledger of a vendor illustrating various credit and debit transactions associated with the vendor;

FIG. 4 schematically illustrating an example of a movement of funds from a payment device holder, which may be deduced using the embodiment; and

FIG. 5 is a block flow diagram of an application of the present method to a payment system.

### DETAILED DESCRIPTION

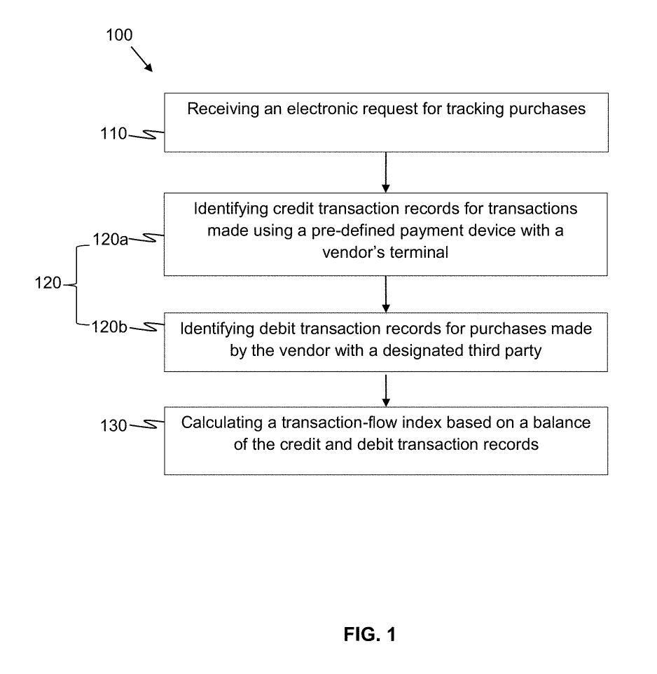

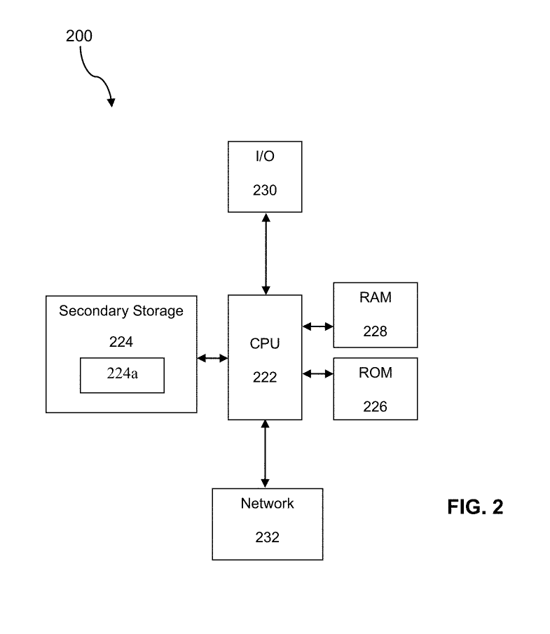

FIG. 1 shows an exemplary method 100 for tracking payments using transactional level data. In particular, a plurality of transactions associated with a single transaction may be identified from a transaction record database to allow tracking of a payment. The transactions are typically carried out at respective levels of the value chain for a product. Typically, the method 100 may be implemented by a computer having a data-processing unit. The block diagram of FIG. 2 illustrates a technical architecture 200 of an apparatus, such as a computer, which is suitable for implementing one or more embodiments.

The technical architecture includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips.

The technical architecture may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has a transaction analysis component 224a comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave. In particular, the network device 232 may allow the CPU 222 to communicate with a database over a network to obtain and/or process the transaction records.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 222, the RAM 228, and the ROM 226 are changed, transforming the technical architecture in part into a specific purpose machine or apparatus having the novel functionality taught by the present disclosure. It is fundamental to the electrical engineering and software engineering arts that functionality that can be implemented by loading executable software into a computer.

Various operation of the exemplary method 100 will now be described with reference to FIGS. 1 and 2. It should be noted that enumeration of operations is for purposes of clarity and that the operations need not be performed in the order implied by the enumeration. The embodiments below are illustrated with reference to transactions relating to agricultural activities, it will be understood that the present method is not limited to this context.

At step 110, the computer receives an electronic request for tracking payments. The electronic request may be received via a communication network. The electronic request may be made in respect of purchases associated with a particular cardholder, a payment device, a vendor, and/or an order made via a payment network.

At step 120, a transaction analysis component 224a obtains transaction records of a plurality of transactions from at least one database storing transaction records of transactions carried out over a payment network. The plurality of transactions are related to a vendor. For example, the transactions are performed between the vendor and another party, such as a farmer. The transaction record includes a plurality of information fields describing details of the transaction including a transaction amount.

As shown in FIG. 1, at sub-step 120a, the transaction analysis component 224a identifies one or more credit transaction records in respect of an order made by a first party, such as a farmer, with the vendor. The credit transaction records are typically shown as credits on the vendor's account (or ledger). In other words, the transaction involves an amount of funds charged to the payment device of the farmer by the vendor, for example, through a point-of-sale (POS) terminal of the vendor. In one example, the amount of transaction is charged to a dedicated credit card of the farmer. The dedicated credit card is a credit card issued by an issuing bank for the purpose of carrying out transactions with a list of pre-defined vendors. In other words, this may allow transactions carried out by the cardholders of dedicated credit cards with the vendor to be easily identified for tracking purposes. In one example, the dedicated credit card is authorized for carrying out transactions with the pre-defined merchants for limited purposes prescribed by the credit card issuing bank only. For example, transaction restrictions may be imposed by the issuing bank so that transactions may be approved only for transactions carried out with the list of selected merchants (e.g. merchants offering seeds and fertilizer), and not with other merchants or via other modes of transactions such as cash withdrawal.

At sub-step 120b, the transaction analysis component 224a identifies one or more debit transaction records associated with purchases made by the vendor with a designated third party. The debit transaction records are typically shown as debits on the vendor's account (or ledger). In other words, the transaction involves a payment made by the vendor for a purchase made with a designated wholesaler via a payment network. There may be a plurality of designated wholesalers which are recommended for the vendor. In another example, the designated wholesalers are the exclusive merchants from whom the vendor is permitted to make the purchase.

The payment network may be any electronic payment network which connects, directly and/or indirectly payers (the consumer and/or their banks or similar financial institutions) with payees (the merchant and/or their banks or similar financial institutions). It will be understood that the payers and payees may differ in different transactions. For example, for the transactions between the farmer and the vendor, the consumer is the farmer and the vendor is the merchant. While for transactions between the vendor and the wholesaler, the former is the consumer and the latter is the merchant. Non-limiting examples of the payment network are a payment card type of network such as the payment processing network operated by MasterCard, Inc., mobile telephone payment networks and the like (it should be noted that the primary purpose of the payment network may not be payment; for example, a mobile telephony network may offer payment network capability even though its primary purpose may be mobile telephony). It will be understood that the computer may be implemented as a purchase-tracking server operable by a payment system provider such as MasterCard.

The transaction record may further comprise an identity of payment device associated with each of the transactions. The payment device is any suitable cashless payment device that can be used as a method of payment for performing a transaction. The payment device is typically a payment card such as such as a credit card, a membership card, a promotional card, an identification card, a prepaid card, a gift card, and/or any other device that may hold payment account information, such as mobile phones, Smartphones, personal digital assistants (PDAs), key fobs, transponder devices, NFC-enabled devices, and/or computers. The information about the payment device may include a card number, account number and/or any other payment device identifier which allows the payment device to be uniquely identified.

The transaction records can be received directly from the payment network over a communication network, or from a database in communication with the system 200, e.g. a data warehouse which stores transaction data from the payment network.

The information fields of the transaction record may further comprise an acquirer identifier/card accepter identifier (the combination of which uniquely defines a merchant—the vendor or any other goods or service provider); a merchant category code (also known as card acceptor business code), that is, an indication of the type of business the merchant is involved in (for example, a farming supplier); the cardholder base currency (i.e., U.S. Dollars, Euros, Yen, etc.); a transaction time and date; a location (full address and/or GPS data); and/or a terminal identifier (e.g., merchant terminal identifier or ATM identifier).

At step 130, the transaction analysis component calculates a transaction-flow index based on a balance of the one or more credit and debit transaction records. The transaction-flow index indicates a likelihood that the purchases made by the vendor from the wholesalers are intended for fulfilling the one or more orders made by the cardholders. The balance of the one or more credit and debit transaction records are determined at regular time intervals, such as daily, weekly, bi-weekly, monthly, etc.

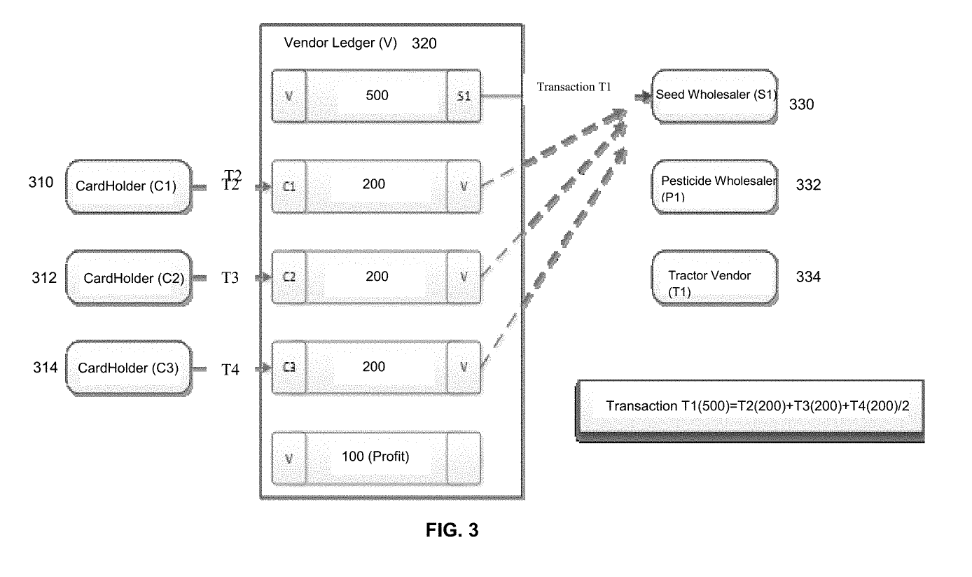

FIG. 3 shows an example of a ledger of a vendor 320 illustrating various credit and debit transactions associated with the vendor 320. Cardholders 310, 312, 314 are farmers who hold dedicated credit cards authorized for carrying out transactions with the vendor 320 for agricultural supplies. The vendor 320 may make purchase from a list of designated wholesalers, such as a seed wholesaler 330, a pesticide wholesaler 332, and a tractor vendor 334 for fulfilling the order made by the farmers. Each of the cardholders 310, 312, 314 makes a respective transaction T2, T3, T4 with the vendor 320 for orders of agricultural supplies such as seeds. These transactions T2, T3, T4 create credit transaction records which are reflected as credits on the ledger of the vendor 320. As shown, the vendor 320 has made a purchase T1 with the seed wholesaler 330. In this example, the amount of the debit (outgoing) transaction T1 is $500, and this amount is offset by the total amount of credit transactions T2, T3, T4, which is $600, as illustrated by the equation in FIG. 3. This creates a credit balance of $100 in the ledger of the vendor 320, which accounts for the net profit made by the vendor 320. Thus, it may be deduced that the movement of the funds has taken place from the cardholder 310 to the seed wholesaler 330 via the vendor 320. Therefore, it may be concluded that the vendor 320 has made a purchase from the seed wholesaler 330 for fulfilling the orders of the cardholders 310, 320, 330. In addition, it may be deduced that the transaction made using the credit card by the cardholder 310 (and similarly for the other two cardholders 312, 314) is for the purposes of purchasing the seeds. This means that the purpose (e.g. for agricultural supplies) of the transaction carried out by the credit card has been substantiated.

When new transactions are added, it may be balanced with an existing open (i.e. unbalanced) transaction of the opposing effect. For example, when a new debit transaction record is added as the current transaction, it will be balanced with all the historical debit transactions. The balancing may be performed on a basis of the value and a first-in-first-out (FIFO) order of the transaction. Any unbalanced amount of the current transaction may be added to the unbalanced transaction for the account based its credit or debit type.

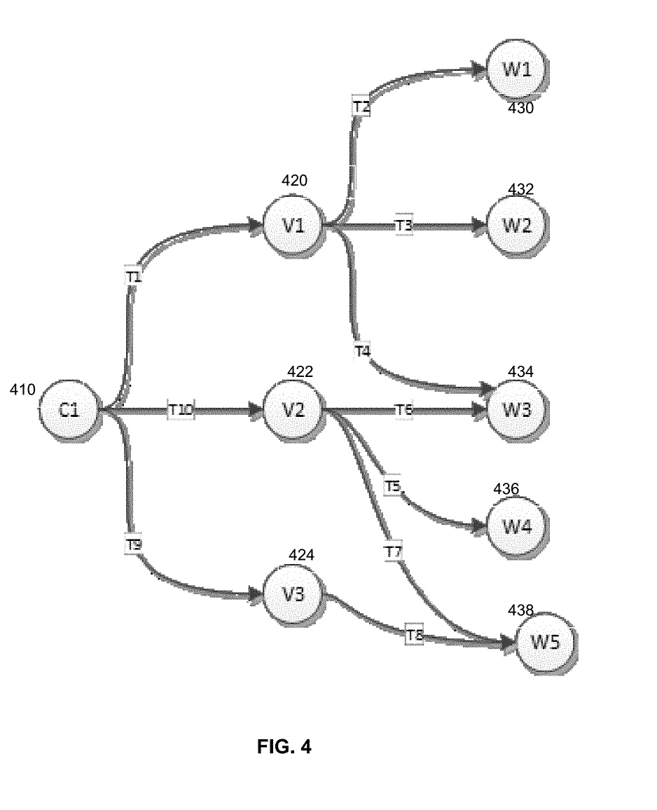

In one embodiment, by aggregating transactions of the vendor's account, a graph indicative of a flow of funds may be produced as shown in FIG. 4. For simplicity, FIG. 4 assumes that there is only one cardholder, three vendors and five wholesalers. It will be appreciated that in reality, there may be a plurality of cardholders carrying out transactions with a plurality of vendors, and each of the vendors may receive products from one or more wholesalers, and the present method may be adapted accordingly.

Referring to FIG. 4, there are a credit transaction record for a transaction T1 made between a cardholder 410 and a first vendor 420, and debit transaction records for three transactions T2, T3, T4 carried out between the first vendor 420 and each of three wholesalers 430, 432, 434, respectively. Transaction records associated with a second vendor 422 show a credit transaction record for a transaction T10 made by the cardholder 410 and debit transaction records for transactions T5, T6, T7 carried out with wholesalers 436, 434, 438 respectively. Similarly, transaction records of a third vendor 424 include a credit transaction T9 made by the cardholder 410 and a debit transaction T8 made with the wholesaler 438. A balance of the transaction records for each of the vendor 420, 422, 424 may be calculated and a transaction-flow index may be calculated based on a difference between the credit transaction records and the debit transaction records. Ideally, the unbalanced amount should represent an amount of the net profit made by the vendor 420, 422, 424 and it should be within a reasonable range. For example, if the amount of T9 is significantly larger than T8, the unbalanced amount for the account of vendor 424 (i.e. the reflected “net profit”) may exceed a justifiable range. This may potentially indicate that a considerable proportion of the funds involved in the transaction T9 may not have been used for making purchase with the wholesaler 428. In other words, this may mean that the transaction T9 is a questionable transaction made by the cardholder 410, that is, the apparent transaction amount for the order with the vendor 424 is not substantiated by the related transaction records. The transactions T9, T8, the vendor 424 and/or the cardholder 410 may be flagged to a relevant party (such as the creditor or a regulatory body) for further investigation. It will be understood that the payment network 70 receives and analyses details of both transaction parties (i.e. the payer and receiver) associated with a payment so as to enable tracking. For example, a card-to-card transfer mechanism such as one provided by MoneySend™ may be employed (but not mandatory) for the payment transaction.

In one embodiment, the transaction analysis component 224a may identify, for each credit transaction, one or more debit transactions as plausible transactions for fulfilling the order corresponding to the credit transaction. The credit transaction record comprises information about a product category of the order and the debit transaction record comprises a merchant category code of the wholesaler. This may allow the credit transaction to be mapped to one or more debit transactions using the category of the ordered goods or services. This may help to achieve more detailed and definite tracing of the movement of funds. This may be useful for identifying (when there are more than one cardholders) which cardholder performed the questionable transactions (i.e. when the amount of related credit and debit transactions has a large difference). In another example, different cards may be issued for making purchases of products of different categories to improve traceability of payments. The transaction records for the credit transaction and identified debit transactions may be transmitted to a party who requested the tracking for review. In some examples, only selected information fields of the transaction records are transmitted due to privacy considerations.

### INDUSTRIAL APPLICABILITY

The present disclosure is useful in aligning spending to the purpose of credit. Empowered with traceability, it minimizes disincentives for the guarantor to provide guarantee to borrowers for investments, because traceability of funds will likely increase the guarantor's level of confidence that the investment will be used for intended purposes so that instances of misuse of funds may be minimized. In other words, this reduces a possibility of frauds linked to laundering. In addition, the creation of a list of designated vendors and/or the wholesalers enhances the control of movement of funds. The vendors and/or wholesalers may be selected or certified by a regulatory body in the industry or by the government. Therefore, the accessibility to working capitals is expected to be enhanced due to the traceability of credit flow, even if the borrower does not have a commendable credit history.

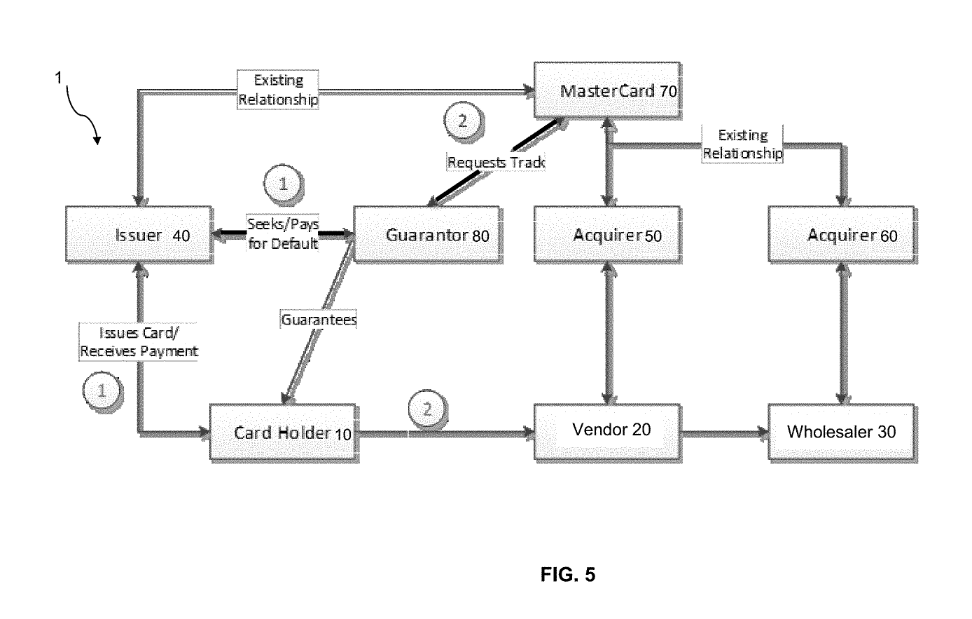

An example of an application of the present method to a payment system 1 is illustrated by FIG. 5.

Referring to FIG. 5, an issuer (i.e. an issuing bank) 40 issues a dedicated credit card to a cardholder 10. The cardholder 10 such as a farmer carries out a transaction with a vendor 20 using the credit card for purchasing agricultural supplies. An acquirer 50 (i.e. the acquiring bank) of the vendor 20 obtains a payment for the transaction via a MasterCard's payment network 70. Similarly, the vendor 20 makes a purchase from a wholesaler 30 to fulfil the order of the cardholder 10 and an acquirer 60 of the wholesaler 30 obtains a payment via the MasterCard's payment network 70 from the vendor 20. Upon expiry of the re-payment period, the cardholder 10 pays off the debts to the issuer 40. The above describes a normal flow of credit card usage and repayment.

However, in the event of default by the cardholder 10 due to extenuating circumstances such as natural disasters, the issuer 40 may seek assistance from a guarantor 80, for example, the government to recover any outstanding debts of the cardholder 10. The guarantor 80 may send a purchase-tracking request to the MasterCard's payment network 70 (e.g. to a MasterCard's purchase-tracking server) to request historical transactions made by the cardholder 10 to be tracked using the present method. Upon the guarantor 80 being satisfied that the expenses incurred demonstrates genuine efforts of the farmer in carrying out farming activities and/or for genuine farming purposes, the guarantor 80 may pay off the debts of the cardholder 10 for him. This minimizes risks to the issuer 40 thereby encouraging them to increase the availability of funds to potential cardholders. At the same time, the guarantor's risk is reduced due to the increased transparency and traceability of the flow of funds. This flow is illustrated in FIG. 5 by the arrows in bold.

Whilst the foregoing description has described exemplary embodiments, it will be understood by those skilled in the art that many variations of the embodiment can be made within the scope and spirit of the present invention.

1. A computer-implemented method for tracking payments comprising:
(a) receiving an electronic request for tracking payments;
(b) obtaining, by a transaction analysis component, transaction records representing a plurality of transactions associated with a vendor from at least one database, each said transaction record comprises a plurality of information fields including a transaction amount, said plurality of transactions being performed via a payment network, operation (b) further comprising:
(i) identifying one or more credit transaction records representing one or more first transactions made using one of pre-defined payment devices with a terminal of the vendor, said one or more first transactions being for one or more orders made with the vendor, and
(ii) identifying one or more debit transaction records representing one or more second transactions, wherein the one or more second transactions are purchases made by the vendor with one of designated third parties; and
(c) calculating, by the transaction analysis component, a transaction-flow index representing a likelihood of the purchases being for fulfilling the one or more orders, based on a balance of the one or more credit and debit transaction records.

2. The computer-implemented method according to claim 1, wherein said pre-defined payment devices are associated with respective payment device holders.

3. The computer-implemented method according to claim 1, wherein said payment device is a credit card authorized to perform a transaction only with a pre-defined list of vendors.

4. The computer-implemented method according to claim 1, wherein said plurality of information fields comprise a transaction time.

5. The computer-implemented method according to claim 1, wherein said plurality of information fields comprises an identity of the payment device.

6. The computer-implemented method according to claim 1, wherein operation (c) comprises calculating the balance of the one or more credit and debit transaction records at pre-defined time intervals.

7. The computer-implemented method according to claim 1 further comprising, for one of the first transactions, identifying one or more of the second transactions as plausible transactions for fulfilling the order of the corresponding first transaction.

8. The computer-implemented method according to claim 1, wherein said credit transaction record comprises information about a product category of said order.

9. The computer-implemented method according to claim 1, wherein the debit transaction record comprises a merchant category code of said designated third party.

10. The computer-implemented method according to claim 7 further comprising transmitting the transaction records of the plausible transactions and the corresponding first transaction on demand.

11. The computer-implemented method according to claim 10 further comprising selecting a sub-set of the information fields of each said transaction record for transmission.

12. An apparatus for tracking payments, said apparatus comprising:
a computer processor and a data storage device, the data storage device storing non-transitory instructions operative by the processor to cause the processor to perform the operations of:
(a) receiving an electronic request for tracking payments;
(b) obtaining transaction records representing a plurality of transactions associated with a vendor from at least one database, said plurality of transactions being performed via a payment network, comprising:
(i) identifying one or more credit transaction records representing one or more first transactions made using one of pre-defined payment devices with a terminal of the vendor, said one or more first transactions being for one or more orders made with the vendor, and
(ii) identifying one or more debit transaction records representing one or more second transactions, wherein the one or more second transactions are purchases made by the vendor with one of designated third parties; and
(c) calculating a transaction-flow index representing a likelihood of the purchases being for fulfilling the one or more orders, based on a balance of the one or more credit and debit transaction records.

13. The apparatus according to claim 12, wherein said pre-defined payment devices are associated with respective payment device holders.

14. The apparatus according to claim 12, wherein said payment device is a credit card.

15. The apparatus according to claim 12, wherein said plurality of information fields comprise a transaction time.

16. The apparatus according to claims 12, wherein said plurality of information fields comprises an identity of the payment device.

17. The apparatus according to claim 12, wherein the data storage device further stores non-transitory instructions operative by the processor to cause the processor to calculate the balance of the one or more credit and debit transaction records at pre-defined time intervals.

18. The apparatus according to claim 12, wherein the data storage device further stores non-transitory instructions operative by the processor to cause the processor to, for one of the first transactions, identify one or more of the second transactions as plausible transactions for fulfilling the order of the corresponding first transaction.

19. The apparatus according to claim 12, wherein said credit transaction record comprises information about a product category of said order.

20. The apparatus according to claim 12, wherein the debit transaction record comprises a merchant category code of said designated third party.

21. The apparatus according to claim 18, wherein the data storage device further stores non-transitory instructions operative by the processor to cause the processor to, transmit the transaction records of the plausible transactions and the corresponding first transaction.

22. The apparatus according to claim 21, wherein the data storage device further stores non-transitory instructions operative by the processor to cause the processor to select a sub-set of the information fields of each said transaction record for transmission.

23. A non-transitory computer-readable medium for tracking payments, the computer-readable medium having stored thereon program instructions for causing at least one processor to perform operations of:
(a) receiving an electronic request for tracking payments;
(b) obtaining transaction records representing a plurality of transactions associated with a vendor from at least one database, said plurality of transactions being performed via a payment network, comprising:
(i) identifying one or more credit transaction records representing one or more first transactions made using one of pre-defined payment devices with a terminal of the vendor, said one or more first transactions being for one or more orders made with the vendor, and
(ii) identifying one or more debit transaction records representing one or more second transactions, wherein the one or more second transactions are purchases made by the vendor with one of designated third parties; and
(c) calculating a transaction-flow index representing a likelihood of the purchases being for fulfilling the one or more orders, based on a balance of the one or more credit and debit transaction records.

24. A non-transitory computer-readable medium according to claim 23, wherein said pre-defined payment devices are associated with respective payment device holders.

25. A non-transitory computer-readable medium according to claim 23, wherein said payment device is a credit card.

26. A non-transitory computer-readable medium according to claim 23, wherein said plurality of information fields comprise a transaction time.

27. A non-transitory computer-readable medium according to claim 23, wherein said plurality of information fields comprises an identity of the payment device.

28. A non-transitory computer-readable medium according to claim 23 further storing non-transitory instructions operative by the processor to cause the processor to calculate the balance of the one or more credit and debit transaction records at pre-defined time intervals.

29. A non-transitory computer-readable medium according to claim 23 further storing non-transitory instructions operative by the processor to cause the processor to, for one of the first transactions, identify one or more of the second transactions as plausible transactions for fulfilling the order of the corresponding first transaction.

30. A non-transitory computer-readable medium according to claim 23, wherein said credit transaction record comprises information about a product category of said order.

31. A non-transitory computer-readable medium according to claim 23, wherein the debit transaction record comprises a merchant category code of said designated third party.

32. A non-transitory computer-readable medium according to claim 29 further storing non-transitory instructions operative by the processor to cause the processor to transmit the transaction records of the plausible transactions and the corresponding first transaction.

33. A non-transitory computer-readable medium according to claim 32 further storing non-transitory instructions operative by the processor to cause the processor to select a sub-set of the information fields of each said transaction record for transmission.
